(19) United States
(12) Patent Application Publication
(10) Pub. No.: US 2009/0274511 A1
(43) Pub. Date: Nov. 5, 2009

(54) Telescopic tube and cam connecting and locking mechanism

(75) Inventor: Shi-Neng Chen, Guangzhou City (CN)

Correspondence Address: COHEN, PONTANI, LIEBERMAN & PAVANE LLP, 551 FIFTH AVENUE, SUITE 1210, NEW YORK, NY, 10176, US

(73) Assignee: Photographic Research Oganization, Inc.

(21) Appl. No.: 12/380,862

(22) Filed: Mar. 4, 2009

(30) Foreign Application Priority Data
Apr. 30, 2008 (CN) 200820047222.9

(51) Int. Cl. F16B 7/14

(52) U.S. Cl. 403/109.5

(57) ABSTRACT

A telescopic tube and cam connecting and locking mechanism includes a first bushing having a first diameter, a second bushing having a second diameter which is larger than the first diameter, an expandable cam bushing received in the second bushing and fixed against rotation relative to the second bushing, and a camshaft having a first portion received in the first bushing and a second portion received in the cam bushing. The first portion is fixed against rotation relative to the first bushing, and the second portion is rotatable relative to the cam bushing to expand the cam bushing against the second bushing and lock the first and second bushings against relative movement. A clamp bushing received on the first bushing and engaging the second bushing has an inner diameter that is smaller than the outer diameter of the cam bushing.

### BACKGROUND OF THE INVENTION

1. Field of the Invention

The invention relates to a telescopic tube or rod, in particular a telescopic tube and cam connecting and locking mechanism for a still camera or video camera tripod.

3. Description of the Related Art

Telescopic tube connecting and locking devices currently on the market for a still camera or video camera are usually either retaining pawl or nut and thread connecting and locking devices. When using such a telescopic tube for a tripod, the telescopic tube can only be extended or contracted by pulling open the retaining pawl or twisting open the nuts on each tube. The operations are rather elaborate. In addition, the telescopic tubes and nuts for such a tripod are rather complex to process, with a higher cost; the retaining pawls or nuts on each tube are rather large, making it inconvenient to store or carry a tripod.

### SUMMARY OF THE INVENTION

In response to the above deficiency in the existing telescopic tubes for tripods, an object of the present invention is to provide a telescopic tube and cam connecting and locking mechanism that is smaller, easy and flexible to operate, at a lower cost.

According to the invention, a telescopic tube and cam connecting and locking mechanism includes more than two bushings. The diameters of the bushings are not equal. A first bushing with a smaller diameter is slid into and connected to the inside of a second bushing with a larger diameter, and they may slide and rotate relative to one another. The first and second bushings are connected and fastened to each other through a connecting and locking mechanism having an inner clamp bushing placed on one end of the second bushing and a cam device placed on one end of the first bushing. The inner diameter of the aforementioned inner clamp bushing is smaller than the outer diameter of the cam device; this prevents the first bushing from sliding inside the second bushing or rotating to a certain angle without becoming detached.

The aforementioned cam device includes a camshaft and an outer cam bushing. The diameter of the outer cam bushing can be enlarged by the rotating camshaft, so that the cam device can be pushed closely against the inner wall of the second bushing, thus connecting and fastening the first bushing to the second bushing.

According to a preferred embodiment, the aforementioned cam bushing comprises two opposed shells placed opposite each other on the outer surface of the camshaft.

According to a preferred embodiment, there are smooth surfaces or patterns on the outer surfaces of the cam shells.

According to a preferred embodiment, the camshaft of the aforementioned cam device is a blind tube structure with a central cavity. There is a plug in the hollow cavity of the camshaft.

According to a preferred embodiment, cylindrical nubs are provided on the inner clamp bushing and camshaft. The cylindrical nubs on the inner clamp bushing are adapted to holes on the second bushing. The cylindrical nubs on the camshaft are adapted to the holes on the first bushing, thus connecting and fastening the inner clamp bushing and the camshaft in adjacent bushings.

According to a preferred embodiment, a sliding guide rib is provided in the first bushing. There is a sliding guide groove on the camshaft. The guide rib is received in the guide groove, preventing rotation between the first bushing and the cam device when the first bushing rotates.

According to a preferred embodiment, the inner clamp bushing is replaced by an outer clamp bushing placed on one end of the second bushing. The minimum inner diameter of the outer clamp bushing is smaller than the outer diameter of the cam device.

According to a preferred embodiment, the camshaft has a threaded connection to the first bushing.

According to the invention, the diameter of the cam bushing can be enlarged by the rotating camshaft, so that the cam device can be pushed closely against the inner wall of the second bushing, thus connecting and fastening the first bushing to the second bushing. A plug is placed in the hollow cavity of the camshaft, which prevents the camshaft from becoming deformed if it is subject to too much force. The invention reduces the cost and size of a telescopic tube, makes its operations easier and more flexible and easier to store and carry, so that it is especially suitable for use on tripods for still cameras and video cameras.

### BRIEF DESCRIPTION OF THE DRAWING

FIG. 1 is a schematic exploded perspective view of a first embodiment of the mechanism according to the invention;

FIG. 2 is a cross sectional structural schematic view of the first embodiment;

FIG. 3 is a cross sectional structural schematic view of a second embodiment;

FIG. 4 is a schematic exploded perspective view of the second embodiment;

FIG. 5 is a schematic exploded perspective view of a third embodiment;

FIG. 6 is a schematic exploded perspective view of a fourth embodiment;

FIG. 7 is a schematic view of the fourth embodiment; and

FIG. 8 is a cross sectional structural schematic view of the fourth embodiment taken along the line A-A of FIG. 7.

### DETAILED DESCRIPTION OF THE PREFERRED EMBODIMENT

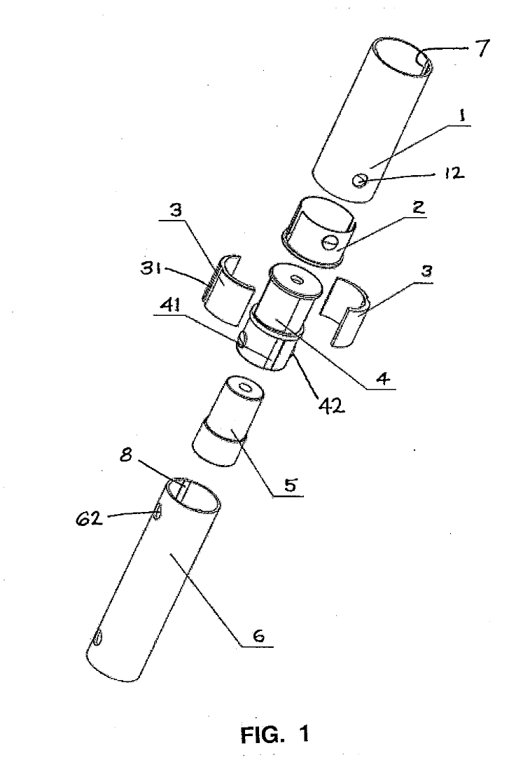

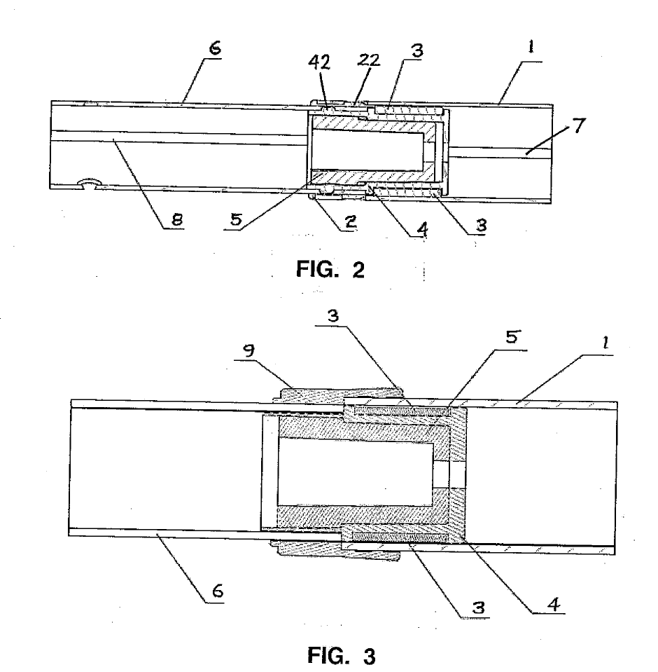

As shown in FIG. 1 and FIG. 2, a telescopic tube and cam connecting and locking mechanism includes two bushings 1, 6 having different diameters. The bushing 6 with a smaller diameter is slid into and connected to the inside of the bushing 1 with a larger diameter, and they may slide and rotate relative to one another. The bushings are connected and fastened to each other through a connecting and locking mechanism including an inner clamp bushing 2 placed in one end of the larger bushing 1 and a cam device 3, 4 placed on one end of the adjacent smaller bushing 6. The inner diameter of the inner clamp bushing 2 is larger than the outer diameter of smaller bushing 6 and smaller than the outer diameter of the cam device, which prevents detachment of the smaller 6 bushing when the larger bushing 1 slides to the end position, thus performing a position limiting function.

In the present embodiment, the cam device includes a camshaft 4 and an outer cam bushing 3. Outer cam bushing 3 comprises two cam shells. The two cam shells are placed opposite each other on the outer circumference of camshaft 4. There are tooth patterns or knurling on the outer surfaces of the two outer cam bushings. The diameter of outer cam shells 3 can be enlarged by rotating camshaft 4, so that the cam device can be pushed closely against the inner wall of the bushing 1 with a larger diameter, thus connecting and fastening the bushing 6 with a smaller diameter 6 to the bushing with a larger diameter 1. The camshaft 4 is a blind tube structure with a central cavity which receives a plug 5.

In the present embodiment, cylindrical nubs 22, 42 are provided on the inner clamp bushing 2 and camshaft 4, respectively. The cylindrical nubs 22 of inner clamp bushing 2 are adapted to engage the holes 12 provided on the bushing 1 thus connecting and fastening inner clamp bushing 2 to the larger bushing 1. The cylindrical nubs 42 of camshaft 4 are adapted to engage the holes 62 provided on the bushing 6, thus connecting and fastening camshaft 4 to the smaller bushing 6. All nubs 22, 42 have axially facing ramped surfaces to facilitate entry into the corresponding bushing. Sliding guide ribs 7, 8 are provided on the inner walls of respective bushings 1, 6. Sliding guide grooves 31, 41 are provided on bushing shells 3 and camshaft 4 of the cam device. Sliding guide ribs 7 are adapted to sliding guide grooves 31 on shells 3, and sliding guide ribs 8 are adapted to sliding guide grooves 41 on camshaft 4, so that camshaft 4 can move along sliding guide ribs 7, 8 of the bushings and can also rotate by rotating the smaller bushing 6 to expand the shells 3 against the bushing 1, thus achieving the connecting, fastening and locking of the large and small bushings by the cam connecting and locking mechanism.

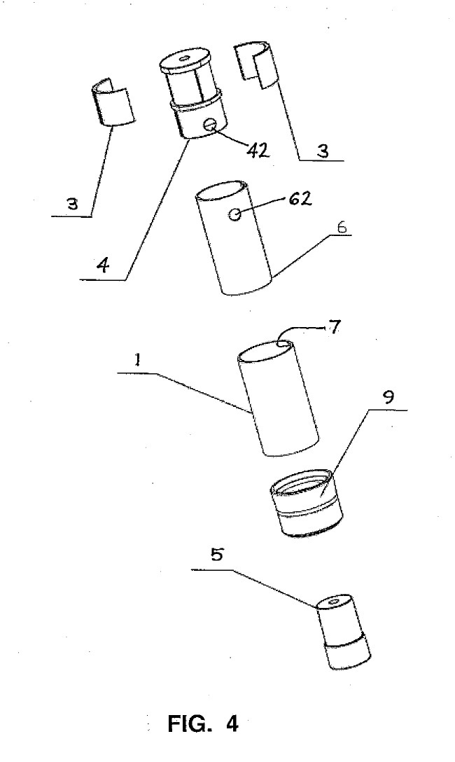

According to a second embodiment, shown in FIG. 3 and FIG. 4, outer clamp bushing 9 replaces inner clamp bushing 2 of the first embodiment. Once again the camshaft 4 has nubs 42 which mate with holes 62 in smaller bushing 6. Outer clamp bushing 9 is placed on one end of the bushing 1 with a larger diameter. The minimum inner diameter of outer clamp bushing 9 is smaller than the outer diameter of the cam device 3, 4, which prevents detachment of the bushing 6 with a smaller diameter when the bushing 1 with a larger diameter slides to the end position, thus performing a position limiting function. Other embodiment methods are the same as in the first embodiment.

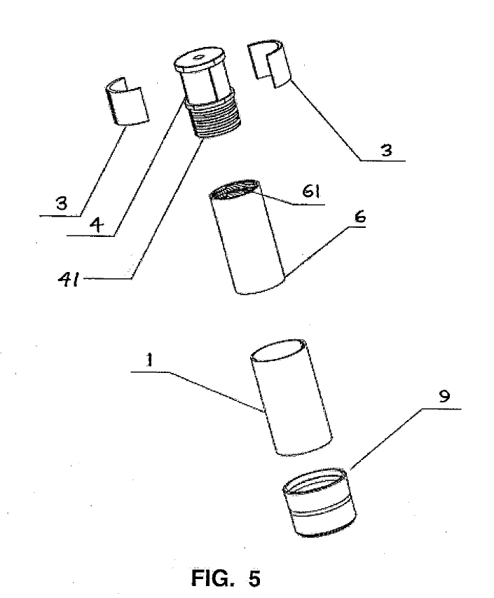

According to a fourth embodiment, shown in FIG. 5, the nub/hole connection between camshaft 4 and the bushing 6 as described in the second embodiment is replaced a thread connection method. An outer thread 41 on one end of camshaft 4 and inner thread 61 on one end of the smaller bushing 6 are adapted to each other. Camshaft 4 and the bushing 6 are connected through thread 41 and thread 61. Other details are the same as in the second embodiment.

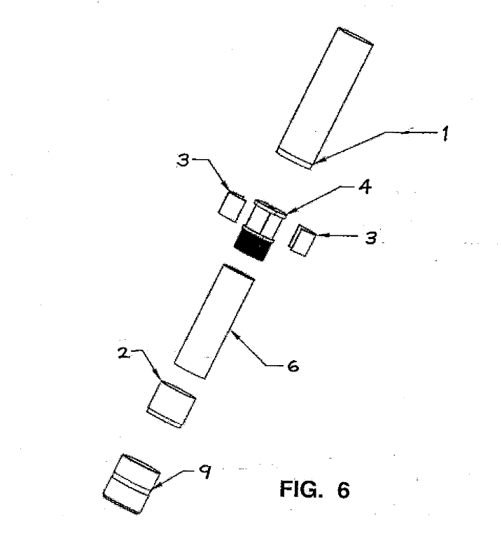

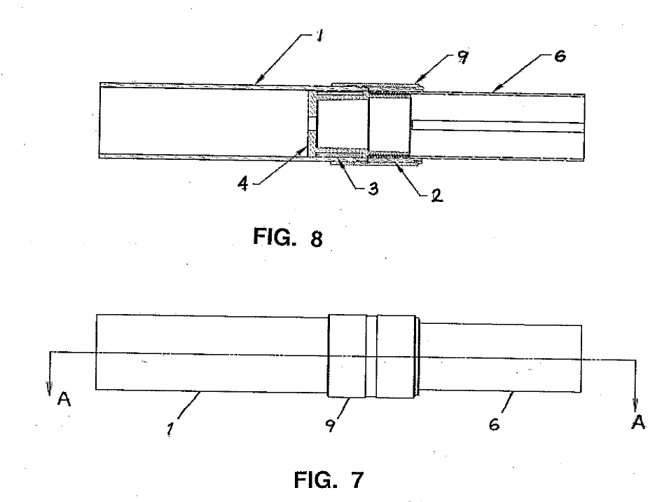

According to a fourth embodiment, shown in FIG. 6, the nub/hole connection between camshaft 4 and the bushings 1,6 as described in the first embodiment is replaced by a thread connection. An outer thread on one end of camshaft 4 and an inner thread on one end of the smaller bushing 6 are adapted to each other. Camshaft 4 and bushing 6 are connected by the threads. Outer cam bushing 3 and camshaft 4 are combined and both enter large tube 3. Inner clamp bushing 2 is slid into outer clamp bushing 9, so that smaller tube 6 is connected and fastened to large tube 1 through an inner hole of inner clamp bushing 2, so that the camshaft 4 does not become externally detached when it is loose. Other details are the same as in the first embodiment.

We claim:

1. A telescopic tube and cam connecting and locking mechanism comprising:
a first bushing having a first diameter;
a second bushing having a second diameter which is larger than said first diameter;
an expandable cam bushing received in said second bushing and fixed against rotation relative to said second bushing;
a camshaft having a first portion received in said first bushing and a second portion received in said cam bushing, said first portion being fixed against rotation relative to said first bushing, said second portion being rotatable relative to said cam bushing to expand said cam bushing against said second bushing so that said first and second bushings are locked against relative movement; and
a clamp bushing received on said first bushing and engaging said second bushing, said clamp bushing having an inner diameter that is smaller than the outer diameter of the cam bushing.

2. The mechanism of claim 1 wherein the expandable cam bushing comprises a pair of opposed cam shells.

3. The mechanism of claim 2 wherein the opposed cam shells have outer surfaces provided with tooth patterns.

4. The mechanism of claim 1 wherein the camshaft is a blind tube with an open end in the first portion, and a plug received in the open end.

5. The mechanism of claim 1 wherein the first portion of said camshaft has at least one cylindrical nub which is received in a respective at least one hole in said first bushing.

6. The mechanism of claim 5 wherein the clamp bushing is an inner clamp bushing received between the first bushing and the second bushing, the inner clamp bushing having at least one cylindrical nub which is received in a respective at least one hole is said second bushing.

7. The mechanism of claim 1 wherein the first portion of the camshaft has at least one groove and the first bushing has at least one rib which can slide in said groove and prevents relative rotation between the camshaft and the first bushing.

8. The mechanism of claim 1 wherein the expandable cam bushing has at least one groove and the second bushing has at least one rib which can slide in said groove and prevents relative rotation between the cam bushing and the second bushing.

9. The mechanism of claim 1 wherein the clamp bushing is an outer clamp bushing having a first portion received on said first bushing and a second portion received on said second bushing.

10. The mechanism of claim 1 wherein the clamp bushing is an inner clamp bushing received on the first bushing and abutting the second bushing, the mechanism further comprising an outer clamp bushing having a first portion received on said first bushing and a second portion received on said second bushing.
